(19) United States
(12) Patent Application Publication
(10) Pub. No.: US 2024/0086340 A1
(43) Pub. Date: Mar. 14, 2024

(54) DATA PROCESSING SYSTEMS

(71) Applicants: ARM LIMITED, Cambridge, Cambridgeshire (GB); APICAL LIMITED, Cambridge, Cambridgeshire (GB)

(72) Inventors: Håkan Lars-Göran PERSSON, Lund (SE); Vladimir DOLZHENKO, Cambridge, Cambridgeshire (GB)

(21) Appl. No.: 18/261,604

(22) PCT Filed: Jan. 24, 2022
(86) PCT No.: PCT/GB2022/050179

§ 371 Date: Jul. 14, 2023

(30) Foreign Application Priority Data
Jan. 22, 2021 (GB) 2100858.6

(51) Int. Cl. G06F 13/16

(52) U.S. Cl. CPC G06F 13/16; G06F 2213/16

(57) ABSTRACT

A data processing system that comprises a processing unit and a communications bus over which bus transactions to access memory can be performed is disclosed. The system includes a codec, and the processing unit can initiate over the communications bus, bus transactions that comprise the codec accessing the memory.

### BACKGROUND

The technology described herein relates to data processing systems, and in particular to compression and decompression in data processing systems, such as graphics processing systems.

A graphics processor (graphics processing unit (GPU)) typically performs graphics processing operations by processing data in an uncompressed form. When such operations have produced a particular output (e.g. frame), the output data may be written to memory for storage before further processing by the graphics processor.

To reduce the amount of data that needs to be transferred to and from memory, and the associated power cost of moving such data back and forth, the data may be compressed before being written to memory. This allows the data to be stored in a compressed format. Then, when the graphics processor requires the data for further processing, the compressed data is read from memory and decompressed, such that it is then in a suitable format for processing by the graphics processor.

The Applicants believe that there remains scope for improvements to compression and decompression arrangements in data processing systems.

### BRIEF DESCRIPTION OF THE DRAWINGS

Embodiments of the technology described herein will now be described by way of example only and with reference to the accompanying drawings, in which:

FIG. 1 shows a data processing system in accordance with an embodiment of the technology described herein;

FIG. 2 shows schematically a data processing system operating in accordance with embodiments of the technology described herein;

FIGS. 3A, 3B and 3C show schematically memory layouts in accordance with embodiments of the technology described herein;

FIGS. 4A and 4B show schematically a compressed data read transaction in accordance with an embodiment of the technology described herein;

FIGS. 5A and 5B show schematically a compressed data write transaction in accordance with an embodiment of the technology described herein;

FIGS. 6A and 6B show schematically data processing systems in accordance with embodiments of the technology described herein; and

FIG. 7 shows schematically a codec unit in accordance with an embodiment of the technology described herein.

Like reference numerals are used for like components where appropriate in the drawings.

### DETAILED DESCRIPTION

A first embodiment of the technology described herein comprises a data processing system comprising:
a processing unit;
a codec; and
a communications bus over which bus transactions to access memory can be performed;
wherein the processing unit is operable to initiate over the communications bus, bus transactions that comprise the codec accessing the memory; and
the codec is operable to, in response to the processing unit initiating such a bus transaction over the communications bus, access the memory.

A second embodiment of the technology described herein comprises a method of operating a data processing system that comprises:
a processing unit;
a codec; and
a communications bus over which bus transactions to access memory can be performed;
wherein the processing unit is operable to initiate over the communications bus, bus transactions that comprise the codec accessing the memory; and
the codec is operable to, in response to the processing unit initiating such a bus transaction over the communications bus, access the memory;
the method comprising:
the processing unit initiating over the communications bus, a bus transaction in which the codec is to access the memory; and
the codec accessing the memory in response to the processing unit initiating the bus transaction over the communications bus.

The technology described herein relates to a data processing system, such as, and in an embodiment, a graphics processing system, that includes a codec unit that is operable to compress and decompress data.

The system includes a processing unit, such as, and in an embodiment, a central processing unit (CPU) or a graphics processing unit (GPU), that is, in an embodiment, able to access memory via a communications bus (interconnect) by initiating bus transactions on the bus (interconnect). The processing unit may thus be, and in an embodiment is, operable to act as a bus master. The bus transactions that the processing unit can initiate may, and in an embodiment do, include bus transactions in which the processing unit accesses memory of the data processing system to read or write uncompressed data in the memory.

In the technology described herein, as well as being able to initiate such e.g. “direct” bus transactions that will e.g. involve uncompressed data being read or written by the processing unit, the processing unit can initiate bus transactions in which the (compression) codec will access memory. As will be discussed in more detail below, these “codec bus transactions” may, and in an embodiment do, include the codec accessing memory to read or write compressed data in the memory, or to read or write metadata associated with compressed data in the memory.

In particular, the codec may, and in an embodiment does, during a “codec” bus transaction triggered by the processing unit, compress data provided by the processing unit and write the compressed data to memory, or read compressed data from memory, decompress the compressed data, and provide decompressed data to the processing unit.

The Applicants have recognised that it is possible to configure a data processing system such that processing units, e.g. CPUs and/or GPUs, can use bus transactions to communicate with, and thereby control, a codec. By using bus transactions to control a codec, the codec unit need only be accessible via the communications bus, and thus can be less tightly integrated with the processing unit (or units) that requires compression and decompression operations.

This can allow more flexible arrangements for compression and decompression in a data processing system. For example, in the technology described herein, multiple different processing units can, and in an embodiment do, control the same single (e.g. external) codec using bus transactions, and similarly, a single processing unit can, and in an embodiment does, control multiple different (e.g. external) codecs that e.g., and in an embodiment, implement different encoding (compression) schemes.

Moreover, the use of bus transactions in the manner of the technology described herein can provide this flexibility in a particularly straightforward and efficient manner. For example, the Applicants have recognised that relatively small modifications to existing bus protocols, such as AXI, can allow control of a codec using bus transactions in the manner of the technology described herein.

Moreover, in the technology described herein, a processing unit can, and in an embodiment does, control a codec via the same bus interface that it uses for other e.g. “direct” bus transactions. The processing unit may thus be able to, and in an embodiment can, access compressed data in memory in essentially the same manner that it accesses uncompressed data in memory, e.g. and in an embodiment, in a “random access” manner. Similarly, the processing unit may be able to control multiple different codec units via the same single bus interface.

This means, for example, that the technology described herein can reduce the overall hardware/silicon area costs associated with performing compression and decompression operations in a data processing system. Moreover, the overall energy consumption of the system when performing compression and decompression operations can be reduced. This is generally advantageous, but may be particularly advantageous in contexts in which resources are limited, such as in portable devices, e.g. mobile phones and tablets.

It will be appreciated, therefore, that the technology described herein provides an improved data processing system.

The processing unit can be any suitable processing unit. The processing unit may be, for example and in an embodiment, a central processing unit (CPU), a graphics processing unit (GPU) (graphics processor), a video processor, a sound processor, an image signal processor (ISP), a digital signal processor (DSP), a neutral network processor or a display controller. Other processing units would be possible.

The processing unit can initiate over the communications bus, bus transactions to access memory (of the data processing system). The processing unit in an embodiment comprises a bus interface (bus adapter) that is in communication with the communications bus (interconnect), and via which the processing unit can initiate bus transactions on the bus (interconnect). The processing unit should be, and in an embodiment is, operable to initiate bus transactions by issuing bus transaction requests on the communications bus (interconnect), and in an embodiment to control bus transactions initiated by the requests. The processing unit should thus be, and in an embodiment is, operable to act as a bus master. Moreover, the system should, and in an embodiment does, comprise a memory which can be accessed via the communications bus.

The memory can be any suitable and desired storage for storing any suitable (e.g. compressed and/or uncompressed (not compressed)) data that the data processing system uses and/or produces, such as and in an embodiment, image data, texture data, graphics processing fragment or vertex data, video data, sound data, neural network data, etc.

There could be one or more, e.g. plural, different memories that can be accessed via the communications bus. In an embodiment, the memory is an external memory (e.g. not on the same chip as the processing unit and/or codec). For example, the memory is in an embodiment a main (system) memory of the data processing system that the codec (and processing unit) can access (via the same (system) bus).

The system may comprise a memory management unit (MMU) associated with the memory that is operable to translate memory addresses appropriately (between logical and physical memory addresses).

The communications bus can be any suitable and desired interconnect over which bus transactions to access the (e.g. main) memory can be performed. The bus may be able to (during a bus transaction) transfer any suitable signals and data to and from (at least) the memory, and for these purposes may comprise any suitable set of channels.

For example, the communications bus may comprise one or more channels for conveying control data, and/or address data, and/or read data, and/or write data (data to be written). There may be separate (independent) channels for control data, address data, and “user” data, or a same channel may be used for two or more of control data, address data, and “user” data. Similarly, there may be separate (independent) channels for read and write transactions, or a same channel may be used for both read and write transactions.

In an embodiment, the communications bus comprises a read address channel, a read data channel, a write address channel, a write data channel, and a write response channel, e.g. and in an embodiment, in accordance with Advanced eXtensible Interface (AXI), as described in AMBA (Advanced Microcontroller Bus Architecture) specifications. Other channel arrangements would be possible.

The system should correspondingly be, and in an embodiment is, configured such that bus transactions are performed in accordance with a bus protocol, such as AXI. The processing unit, bus, memory, codec etc. should accordingly be, and in an embodiment are, configured appropriately to operate in accordance with a bus protocol (of and for the data processing system in question).

The codec can be any suitable coder/decoder unit that can compress and decompress data. The codec should, and in an embodiment does, comprise an encoder and decoder circuit configured to compress and decompress data. The encoder and decoder circuit may comprise an encoder circuit and a decoder circuit, and the encoder circuit and the decoder circuit may comprise separate circuits, or may be at least partially formed of shared processing circuits. The (encoder and decoder circuit of the) (compression) codec should be, and in an embodiment is, configured to compress and decompress data in accordance with a suitable encoding scheme (or schemes). For example, the encoding scheme implemented by the codec may be lossless or lossy, as suitable and desired.

The encoding scheme may, for example, comprise Adaptive Scalable Texture Compression (ASTC), e.g. as described in US 2012/0281007, the entire contents of which is hereby incorporated by reference, or Arm Frame Buffer Compression (AFBC), e.g. as described in US 2013/0036290 and US 2013/0198485, the entire contents of which is hereby incorporated by reference.

In an embodiment, as will be discussed in more detail below, the processing unit can indicate to the codec, via the communications bus, the e.g. encoding scheme and/or options that the codec should use. Thus, the (encoder and decoder circuit of the) codec is in an embodiment configurable over the communications bus.

The codec may be external to (e.g. not on the same chip as) the processing unit. However, in an embodiment, the codec is provided on the same chip as the processing unit. Locating the codec and processing chip on the same chip can reduce energy consumption. The codec unit and processing unit may be able to communicate via the communications bus (interconnect). The codec is in an embodiment (logically) between the processing unit and the (e.g. main) memory, e.g. and in an embodiment, such that the codec can intercept bus transaction communications between the processing unit and the memory.

The codec may be (logically) between the processing unit and a memory management unit, in which case the codec may use logical memory addresses to access the memory. Alternatively, the codec may be (logically) between the memory and a memory management unit, in which case the codec may use physical memory addresses to access the memory.

The codec may be, for example, a standalone module connected to the bus (interconnect), e.g. via a bus interface. Alternatively, the codec may be integrated in the bus (interconnect).

In an embodiment, the codec comprises (in an embodiment, as well as the processing unit) a bus transaction initiating circuit (e.g. a bus interface) configured to initiate over the communications bus, bus transactions to access the memory. In an embodiment, the codec is operable to access the memory by the bus transaction initiating circuit of the codec initiating over the communications bus, a bus transaction to access the memory. Thus, in an embodiment, the arrangement is effectively such that in response to receiving a (first) bus transaction initiated by the processing unit, the codec initiates a (second) bus transaction to access the memory.

It is believed that the idea of a codec being able to initiate bus transactions in this manner may be novel and inventive in its own right.

Thus, another embodiment of the technology described herein comprises a codec comprising:
a bus transaction initiating circuit configured to initiate over a communications bus, bus transactions to access memory; and
a processing circuit configured to, in response to receiving over the communications bus, a request for the codec to access the memory, cause the bus transaction initiating circuit to initiate over the communications bus, a bus transaction to access the memory.

Another embodiment of the technology described herein comprises a method of operating a codec that comprises a bus transaction initiating circuit configured to initiate over a communications bus, bus transactions to access memory; the method comprising:
in response to receiving over the communications bus, a request for the codec to access the memory, causing the bus transaction initiating circuit to initiate over the communications bus, a bus transaction to access the memory.

These embodiments can include, as appropriate, any one or more or all of the optional features described herein. For example, the codec is in an embodiment configurable over the communications bus. Thus, in an embodiment, and as will be discussed in more detail below, in response to the request the (encoder and decoder circuit of the) codec is configured (by the processing circuit) to compress or decompress data, e.g. and in an embodiment, in accordance with (encoding) parameters and/or properties indicated by the request. In an embodiment, the memory access comprises reading the compressed data that is to be decompressed, or writing the compressed data that has been compressed.

As discussed above, providing a codec that can be controlled via bus transactions can facilitate multiple different processing units controlling the same single codec, and a single processing unit controlling multiple different codecs. Thus, in an embodiment the system comprises one or more, and in an embodiment plural, processing units, each of which can trigger the codec to access the memory in the manner of the embodiments described herein. In an embodiment, the system comprises one or more, and in an embodiment plural, codecs, each of which can be triggered by a (the) processing unit to access memory in the manner of the embodiments described herein. In the case of multiple codecs, each codec unit is in an embodiment configured to compress and decompress data differently, e.g. in accordance with a different encoding scheme.

As also discussed above, a (the) processing unit is in an embodiment (also) operable to initiate over the communications bus, bus transactions that comprise the processing unit accessing the memory (without the codec accessing the memory), e.g., direct memory access (DMA) transactions, in an embodiment by issuing appropriate bus transaction requests on (e.g. a control or address channel of) the communications bus. (The processing unit should thus be, and in an embodiment is, operable to access the memory via the communications bus (during a bus transaction).) Such “direct” bus transactions in an embodiment comprise the processing unit accessing the memory to write data to the memory, and/or the processing unit accessing the memory to read data from the memory. In this case, the data that is read from, or written to, the memory is in an embodiment in an uncompressed form.

The processing unit is (also) operable to initiate over the communications bus, bus transactions that comprise a (the) codec accessing the memory, in an embodiment by issuing appropriate bus transaction requests on (e.g. a control or address channel of) the communications bus that trigger the codec to act (operate) appropriately. In other words, the codec can in an embodiment be triggered to access memory by (receiving) an appropriate bus transaction request issued by the processing unit. The codec unit may thus be, and in an embodiment is, operable to act as a bus slave. Moreover, the codec should be, and in an embodiment is, operable to access the memory via the communications bus (during a bus transaction).

The processing unit(s) can in an embodiment initiate (at least) a “codec” bus transaction (in which the codec accesses memory in response to a bus transaction request from the processing unit) that comprises the codec accessing the memory to write data to the memory, and/or the codec accessing the memory to read data from the memory. In this case, the data that is read from, or written to, the memory is in an embodiment in compressed form.

In an embodiment, and as will be discussed in more detail below, the processing unit can also or instead (and in an embodiment also) initiate a “codec” bus transaction that comprises the codec accessing the memory to read (only) metadata from the memory and/or to write (only) metadata to the memory (in an embodiment in relation to, and for, metadata associated with compressed data).

Thus, in an embodiment, the processing unit is operable to initiate (“direct”) bus transactions that comprise the processing unit accessing memory, in an embodiment to read or write uncompressed data, and to initiate (“codec”) bus transactions that comprise the codec accessing the memory, in an embodiment to read or write compressed data and/or metadata associated with compressed data.

The processing unit can initiate a “codec” bus transaction in any suitable and desired manner. In an embodiment, the processing unit can issue an indication that a bus transaction relates to compressed data (and so should comprise the codec accessing the memory), and the codec in an embodiment responds to such an indication appropriately (by accessing the memory appropriately during the bus transaction).

Such a “compressed data” indication issued by the processing unit can take any suitable form. For example, a bus transaction request that initiates a “codec” bus transaction may include an indication that the request relates to compressed data, and the codec may respond appropriately on that basis.

In an embodiment, the processing unit can issue a specific, in an embodiment selected, in an embodiment predetermined, signal that indicates that an associated bus transaction relates to compressed data (and so should comprise the codec accessing the memory). Correspondingly, the codec in an embodiment responds appropriately (accesses the memory) in response to receiving such a “compressed data” signal issued by the processing unit.

Such a “compressed data” signal should be, and in an embodiment is, appropriately defined in the bus protocol. A “compressed data” signal may be issued on and conveyed by any suitable channel of the communications bus, such as a control or address channel of the communications bus, e.g. together with other control information.

In an embodiment, the processing unit can indicate whether or not a bus transaction request should trigger the codec to access memory. The processing unit may, for example, issue a “compressed data” signal when a bus transaction request relates to compressed data, and not issue such a signal (and e.g. issue a different signal) when a bus transaction request does not relate to compressed data (e.g. when it relates to uncompressed data). Moreover, where there can be plural different codecs, the “compressed data” signal may indicate a particular codec that should be triggered to access the memory.

Correspondingly, in an embodiment, a (the) codec determines whether the codec should access memory in response to a received bus transaction request, in an embodiment based on whether or not the request indicates (e.g. by including an appropriate signal) that the codec should do so (e.g. whether or not the request is indicated as being related to compressed data). When it is determined that the codec should access memory in response to a received bus transaction request, the codec in an embodiment accesses the memory as appropriate.

When, however, it is not determined (it is other than determined) that the codec should access memory, the codec in an embodiment does not access the memory. The codec may not respond (at all) to a bus transaction request that does not indicate that the codec should respond (that is not indicated as being related to compressed data). However, in an embodiment, the codec is operable to forward (over the communications bus) any bus transaction requests that do not indicate that the codec should respond (e.g. that are not indicated as being related to compressed data), e.g. and in an embodiment, such that the forwarded requests can reach and trigger other codecs (if present) or other components of the system via the communications bus (interconnect) appropriately.

Thus in an embodiment, a (the) codec includes a bypass circuit that is operable to forward (over the communications bus) received bus transaction requests that do not indicate that the codec should respond (e.g. that are not indicated as being related to compressed data). In other embodiments, however, the system may be configured such that only bus transaction requests that a codec should respond to are received by the codec, e.g. such that requests that are not intended for the codec bypass the codec.

In an embodiment the codec is operable to: determine whether the codec should access the memory in response to a received bus transaction request; when it is determined that the codec should access the memory in response to the received bus transaction request, access the memory; and when it is not determined that the codec should access the memory in response to the received bus transaction request, forward (over the communications bus) the received bus transaction request (without accessing the memory).

As well as being able to indicate that a bus transaction should involve the codec, the processing unit should be able to, and in an embodiment can, indicate to the codec, via the communications bus, the operation that the codec should perform during the bus transaction, e.g. and in an embodiment, whether the codec should read or write data. Correspondingly, as already mentioned, the codec should be, and in an embodiment is, configurable over the communications bus.

Whether the codec should read or write data can be indicated by the processing unit in any suitable and desired manner. For example, the processing unit may issue a “compressed data” signal on the communications bus when the codec is to read data, and issue a different “compressed data” signal on the communications bus when the codec is to write data. In an embodiment, the communications bus comprises independent read and write channels, and the processing unit issues a “compressed data” signal on a read (e.g. control or address) channel when the codec is to read compressed data, and issues a “compressed data” signal on a write (e.g. control or address) channel when the codec is to write compressed data (and the codec is configured to operate in response accordingly).

In an embodiment, as mentioned above, when the processing unit indicates to the codec that compressed data is to be read from the memory, the codec, in response, reads compressed data from the memory, decompresses the read compressed data to produce decompressed data, and provides the decompressed data to the processing unit via the communications bus. Thus, in an embodiment, the processing unit is operable to initiate a (“codec”) bus transaction that comprises the codec reading compressed data from the memory, decompressing the compressed data to produce decompressed data, and providing the decompressed data to the processing unit via the communications bus, in an embodiment by the processing unit issuing an appropriate indication (e.g. signal(s)) on the communications bus.

Similarly, in an embodiment, when the processing unit indicates to the codec that compressed data is to be written to the memory, the codec, in response, compresses data provided by the processing unit via the communications bus to produce compressed data, and writes the compressed data to the memory. Thus, in an embodiment, the processing unit is operable to initiate a (“codec”) bus transaction that comprises the codec compressing data provided by the processing unit via the communications bus to produce compressed data, and the codec writing the compressed data to the memory, in an embodiment by the processing unit issuing an appropriate indication (e.g. signal(s)) on the communications bus.

To facilitate this, in an embodiment, the processing unit can indicate to the codec, via the communications bus, encoding parameters and/or properties that the codec should use when compressing uncompressed data or when decompressing compressed data to produce decompressed data. The processing unit may, for example and in an embodiment, indicate an encoding scheme that should be used.

Similarly, in an embodiment, the processing unit can indicate to the codec, via the communications bus, parameters and/or properties of uncompressed data that the codec is to compress or parameters and/or properties of decompressed data that the codec is to produce. The indicated parameters and/or properties can be any suitable parameters or properties, such as data representation parameters and/or properties, such as RGB/RGBA/YUV, number of components, number of bits (per component), floating point/unsigned/signed integers, etc.

In an embodiment, these indications are in the form of one or more signals that the processing unit can issue on (e.g. a control or address channel of) the communications bus, e.g. together with other control data, and that are in an embodiment defined in the bus protocol.

Thus, in an embodiment, the processing unit is operable to initiate over the communications bus, a bus transaction that comprises the codec receiving, from the processing unit via the communications bus, information indicative of parameters and/or properties to be used when compressing or decompressing data, and compressing or decompressing data in accordance with the indicated parameters and/or properties. This information may, for example, be in the form of a compression descriptor. In an embodiment, in response to receiving the information, the (encoder and decoder circuit of the) codec is configured to compress or decompress data in accordance with the parameters and/or properties indicated by the information.

Thus, an embodiment of the technology described herein comprises a data processing system comprising:
a processing unit;
a codec comprising an encoder and decoder circuit; and
a communications bus over which bus transactions to access memory can be performed;
wherein the processing unit is operable to initiate over the communications bus, a bus transaction that comprises:
the processing unit issuing over the communications bus, a signal that indicates that the codec should access the memory and information indicative of parameters and/or properties to be used by the codec when compressing or decompressing data; and
the codec, in response to receiving the signal over the communications bus, configuring the encoder and decoder circuit to compress or decompress data in accordance with the parameters and/or properties indicated by the information.

An embodiment of the technology described herein comprises a method of operating a data processing system that comprises:
a processing unit;
a codec comprising an encoder and decoder circuit; and
a communications bus over which bus transactions to access memory can be performed;
the method comprising:
the processing unit initiating over the communications bus, a bus transaction that comprises:
the processing unit issuing over the communications bus, a signal that indicates that the codec should access the memory and information indicative of parameters and/or properties to be used by the codec when compressing or decompressing data; and
the codec, in response to receiving the signal over the communications bus, configuring the encoder and decoder circuit to compress or decompress data in accordance with the parameters and/or properties indicated by the information.

These embodiments can include, as appropriate, any one or more or all of the optional features described herein. For example, the bus transaction may comprise the codec decompressing data and returning decompressed data to the processing unit, or compressing data and writing compressed data to the memory.

A “codec” bus transaction request issued by the processing unit on the communications bus can include any other suitable information. In an embodiment, the processing unit can issue an indication of a memory address that the codec should access and/or information from which a memory address that the codec should access can be determined, and the codec accesses a memory address based on the memory address indication (and e.g. reads compressed data therefrom or writes compressed data thereto) in response to receiving the memory address indication via the communications bus. In an embodiment, such a memory address indication is in the form of a signal that the processing unit can issue on (e.g. a control or address channel of) the communications bus, and the codec can receive via the communications bus, and that is in an embodiment defined in the bus protocol.

A memory address indication signal issued by the processing unit may directly indicate to the codec a memory address in the memory that the codec should access. For example, a memory address indication signal may comprise an indication of an actual memory address in the memory to be accessed.

In an embodiment, a memory address indication signal comprises information that the codec can use to determine a memory address in the memory to access.

For example, in the case of an array of data being divided into a plurality of blocks, and compressed data for each block being stored in the memory at a respective memory location that can be determined based on the position within the array that the respective block represents (e.g. as described in US 2013/0036290 and/or US 2013/0198485), a memory address indication signal may comprise an indication of a position within a data array from which the codec can determine a corresponding memory address to access, e.g. in the form of a “base” address that indicates a set of blocks, and an index that indicates a block within that set of blocks.

Indirectly indicating a memory address in this manner can reduce the amount of information that is required to pass between the processing unit and codec over the communications bus to indicate a memory address to access, e.g. as compared to explicitly indicating both “base” and “block” memory addresses. For example, and in an embodiment, a block index may be indicated by one or more least significant bits of address information that passes over the communications bus.

A memory address indication signal issued by the processing unit on the communications bus may include all of the information that the codec requires in order to be able to determine a memory address in the memory that the codec should access to read compressed data from (or write compressed data to).

For example, in the case of a memory address indication signal indicating a base address and an index, there may be an implicit relationship between indices and memory address offsets relative to the base address, such that each index “implies” a particular memory address offset relative to the base address, and such that a memory address to access can be determined (by the codec) from (only) information in the memory address indication signal (and knowledge of the “implicit” relationship). This may be the case, for example and in an embodiment, where a contiguous memory space region (a “chunk”) is divided into fixed sized sub-regions, with each sub-region being associated with a respective index.

In an embodiment, the compressed data may be written to memory together with information that the codec can (later) use to determine a (e.g. the first) memory address at which the compressed data has been written. In this case, a memory address indication signal issued by the processing unit on the communications bus may include less than all of the information that the codec requires in order to be able to determine a memory address in the memory that the codec should access to read compressed data from.

Thus, in an embodiment, the codec, when writing compressed data to memory, writes associated memory address information to memory that can be used to determine a memory address at which the compressed data is stored; and when reading compressed data from memory, reads associated memory address information from memory and uses the read memory address information to determine a memory address from which to read the compressed data.

This memory address information can be provided in any suitable and desired form. In an embodiment, compressed data is stored in the memory in association with a header (with the compressed data being “body” data associated with (and for) its respective header), and memory address information for compressed data is stored in the header associated with that compressed data.

A header may be assigned a contiguous set of memory addresses in memory that is contiguous with, and e.g. before or after, a contiguous set of memory addresses that is assigned for the associated body data.

In an embodiment, the body data for plural blocks is stored together, and the corresponding header for those blocks are stored together. Thus, there will in an embodiment be multiple respective sets of associated header and body data with a single memory region storing all of the header data, and a separate body data region storing all of the body data. In an embodiment, there are respective separate “header” and “body” memory regions for each (in an embodiment fixed size) “chunk”. Other arrangements would be possible.

In the case of a header being used, a memory address indication signal issued by the processing unit on the communications bus in an embodiment indicates a memory address of (e.g. the first memory address of) a header associated with compressed data to be accessed (with the codec then, e.g., and in an embodiment, reading the header and using the memory address information in the header to access the compressed data itself). The codec may thus read header information from, or write header information to, a memory address indicated by a memory address indication signal issued by the processing unit.

The header information may include any suitable information that may be used to determine a memory address at which compressed data is stored, e.g. a memory address of the associated body data. The header data may, for example and in an embodiment, include the size of the associated body data.

In an embodiment, the header information includes memory address offset information that indicates a memory address offset relative to the memory address of the header that can be applied to the memory address of the header to determine a memory address in the memory that the codec may access to read compressed data. Thus, in an embodiment, the codec, in response to receiving a memory address indicating signal that indicates a memory address of a header associated with compressed data to be read (and in an embodiment an index), determines a memory address offset from memory address offset information in the header that indicates a memory address offset relative to the memory address of the header, and determines the memory address of the compressed data to be read from the memory address of the header and the determined memory address offset (and in an embodiment the index).

Correspondingly, in an embodiment, the codec, in response to receiving a memory address indicating signal that indicates a memory address of a header associated with compressed data to be written, writes memory address offset information in the header that indicates a memory address offset between the compressed data and the memory address of the header.

It is believed that the idea of addressing compressed data using an offset relative to a memory address of a header associated with the compressed data may be novel and inventive in its own right.

Thus, another embodiment of the technology described herein comprises a data processing system comprising:
a memory for storing compressed data; and
a processing circuit configured to:
when reading compressed data that is associated with a header from the memory, determine a memory address for the compressed data based on the memory address of the header, and memory address offset information in the header that indicates a memory address offset relative to the memory address of the header for the compressed data; and
when writing compressed data that is associated with a header to the memory, write memory address offset information in the header that indicates a memory address offset relative to the memory address of the header for the compressed data.

Another embodiment of the technology described herein comprises a method of operating a data processing system that comprises a memory for storing compressed data; the method comprising:
when reading compressed data that is associated with a header from the memory, determining a memory address for the compressed data based on the memory address of the header, and memory address offset information in the header that indicates a memory address offset relative to the memory address of the header for the compressed data; and
when writing compressed data that is associated with a header to the memory, writing memory address offset information in the header that indicates a memory address offset relative to the memory address of the header for the compressed data.

These embodiments can include, as appropriate, any one or more or all of the optional features described herein. For example, a processing unit may indicate a memory address, and a codec may determine (and access) a memory address. In an embodiment, memory address offset information in the header can be written or read by the codec during a bus transaction triggered by the processing unit. It will be appreciated that the memory address signalling arrangement that is used should correspond to the particular arrangement of compressed data in memory that is used.

In an embodiment, as already mentioned, a contiguous memory space region (a “chunk”) is divided into fixed sized sub-regions, with each sub-region being associated with a respective index. In this case, one (e.g. the first or last) sub-region may be reserved for header data, and each of the other sub-regions may be reserved for a respective block of compressed (body) data. Alternatively, all of the sub-regions may be reserved for a respective block of compressed data, e.g. where a header is not used.

In this case, there is in an embodiment an implicit relationship between indices and memory address offsets relative to a base (e.g. the first) address of a “chunk”. Thus, in this case, in an embodiment, a memory address indicating signal indicates a base address of a “chunk” and an index indicating one of the sub-regions within that “chunk”. In this case, the codec may be able to determine a (e.g. the first) memory address for a sub-region from a base (e.g. the first) address for a chunk and an index for the sub-region within that chunk (and based on an “implicit” relationship between indices and sub-region memory address offsets) (and based on header information, if present).

As mentioned above, in an embodiment, as well as (or instead of) being able to initiate a (“codec”) bus transaction that comprises the codec reading compressed data itself, the processing unit is operable to initiate a (“codec”) bus transaction that comprises the codec reading metadata associated with compressed data from the memory, and in an embodiment providing the read metadata to the processing unit.

Thus, an embodiment of the technology described herein comprises a data processing system comprising:
a processing unit;
a codec; and
a communications bus over which bus transactions to access memory can be performed;
wherein the processing unit is operable to initiate over the communications bus, a bus transaction that comprises the codec reading metadata associated with compressed data from the memory without reading the compressed data, and returning the read metadata to the processing unit; and
the codec is operable to, in response to the processing unit initiating such a bus transaction over the communications bus, read metadata associated with compressed data from the memory without reading the compressed data, and return the read metadata to the processing unit.

An embodiment of the technology described herein comprises a method of operating a data processing system that comprises:
a processing unit;
a codec; and
a communications bus over which bus transactions to access memory can be performed;
wherein the processing unit is operable to initiate over the communications bus, a bus transaction that comprises the codec reading metadata associated with compressed data from the memory without reading the compressed data, and returning the read metadata to the processing unit; and
the codec is operable to, in response to the processing unit initiating such a bus transaction over the communications bus, read metadata associated with compressed data from the memory without reading the compressed data, and return the read metadata to the processing unit;
the method comprising:
the processing unit initiating over the communications bus, a bus transaction in which the codec is to read metadata associated with compressed data from the memory without reading the compressed data, and return the read metadata to the processing unit; and
the codec, in response to the processing unit initiating the bus transaction over the communications bus, reading the metadata associated with the compressed data from the memory without reading the compressed data, and returning the read metadata to the processing unit.

These embodiments can include, as appropriate, any one or more or all of the optional features described herein.

In these embodiments, the metadata is in an embodiment data that is representative of one or more properties of the associated compressed data. For example, the metadata may be representative of, and in an embodiment derived from, the associated uncompressed data values (that were compressed to produce the associated compressed data). The metadata can thus in an embodiment provide information regarding data which has been compressed without the need to fetch and decompress that data.

The arrangement is in an embodiment such that the processing unit can initiate a (“codec”) bus transaction in which the codec reads (and returns) only metadata associated with compressed data via the communications bus, but does not read (or return) the compressed data itself.

To facilitate these arrangements, the processing unit should be able to, and in an embodiment can, indicate to the codec, via the communications bus, that the codec should access (only) metadata. In an embodiment, the codec can indicate to the codec, via the communications bus, whether the codec should access compressed data or metadata associated with the compressed data. This can be achieved in any suitable and desired manner.

In an embodiment, the processing unit is operable to issue a “compressed data” signal on the communications bus that indicates that compressed data should be accessed, and to issue a different “compressed data” signal on the communications bus that indicates that (only) metadata associated with compressed data should be accessed (and the codec is configured to operate in response accordingly).

The metadata may be stored in the memory in any suitable and desired manner. Where the compressed data is stored in the memory as body data in association with a header (e.g. as discussed above), the metadata is in an embodiment stored in the header for the compressed data in question.

Thus, in an embodiment, the processing unit is operable to initiate a (“codec”) bus transaction that comprises the codec reading (metadata in) a header, in an embodiment without reading associated body data (or other header data, if present), and in an embodiment providing (the metadata read from) the header (in an embodiment without the body data (or other header data)) to the processing unit via the communications bus.

In an embodiment, if in response to a request to read metadata from the processing unit, the codec cannot read such metadata, e.g. due to it not being present in memory, then the codec returns an indication to the processing unit that the metadata could not be read.

Once metadata has been returned to the processing unit via the communications bus, the processing unit may use the metadata in any suitable and desired manner.

In an embodiment, the processing unit uses metadata associated with compressed data to determine whether that compressed data should be decompressed. Thus, in an embodiment, compressed data is decompressed by the codec (only) when metadata associated with the compressed data indicates that the compressed data should be decompressed.

For example, and in an embodiment, the metadata is used for image compositing purposes. In this case, a display controller that is compositing an image for display by combining image data for different layers (that are e.g. stored in different compressed buffers in the memory) may use metadata provided by the codec to determine whether or not compressed data for a layer needs to be read and decompressed to generate the final composited image.

For example, where metadata indicates that image elements are transparent, then the actual colour values for those image elements need not be determined, e.g. as they will not impact the final composited image. Similarly, image data for layers behind opaque image elements may not need to be read and decompressed. Similarly, where metadata indicates that image elements are all the same colour, and indicates that colour, the indicated colour may be used without decompressing the associated compressed data.

Thus, in an embodiment, the metadata indicates whether all elements of a set of image elements that have been compressed are (fully) transparent and/or (fully) opaque and/or the same colour, and in an embodiment the colour. Compressed image data is then in an embodiment decompressed by the codec (only) when appropriate to do so as indicated by the metadata.

Thus, in an embodiment, in response to a request from the processing unit, the codec returns (only) metadata to the processing unit via the communications bus, and the processing unit in an embodiment then uses the returned metadata to determine whether compressed data associated with the metadata should be decompressed. When it is determined that the compressed data should be decompressed, the processing unit in an embodiment issues a (further) request to the codec via the communications bus to read and decompress the compressed data, and in response, the codec reads and decompresses the compressed data, and returns decompressed data to the processing unit via the communications bus. When it is not determined that the compressed data should be decompressed, the processing unit in an embodiment does not issue such a request, and so the codec does not read or decompress the compressed data.

Although the above describes the codec reading metadata, it would also or instead be possible for the processing unit to initiate a bus transaction that involves the codec writing metadata associated with compressed data.

Thus, in an embodiment, the processing unit is operable to initiate over the communications bus, a (“codec”) bus transaction that comprises the codec writing metadata associated with compressed data to the memory.

Similarly, although the above describes metadata indicating whether compressed data should be decompressed, and being used to determine whether to decompress compressed data, metadata may indicate any other suitable data properties, and be used for any other suitable purposes.

For example and in an embodiment, metadata is used for error detection purposes. An error may occur, for example, due to an error in the compression or decompression process, due to a corruption of, or overwriting of, stored compressed data, or due to an error in transporting data over the communications bus (interconnect), etc.

In this case, the metadata in an embodiment comprises a “signature” that is representative of associated compressed data, and that is in an embodiment indicative of and derived from, or based on, the corresponding (e.g. uncompressed or decompressed) data values. Such a “signature” may comprise, e.g., and in an embodiment, any suitable set of derived information that can be considered to be representative of the data values, such as a checksum, a CRC, or a hash value, etc., derived from the data values. Suitable signatures would include standard CRCs, such as CRC32, or other forms of signature such as MD5, SHA 1, etc.

In an embodiment, metadata comprising a signature (e.g. a checksum) is generated based on uncompressed data values, the uncompressed data is compressed, and the signature and compressed data are stored in association with each other in the memory. The signature (e.g. checksum) is then used for error detection purposes when the compressed data is decompressed. In this case, the signature (e.g. checksum) is in an embodiment re-generated from the decompressed data, and compared to the signature (e.g. checksum) stored in the memory that was generated from the uncompressed data. The comparison is in an embodiment used to determine whether an error has occurred (or not).

It would also or instead be possible to generate a signature (e.g. a checksum) from compressed data (and perform a comparison based on such a signature). For example, in the case of a lossy compression scheme, a signature generated from compressed data may capture some types of errors.

A comparison of signatures can be used to determine whether an error has occurred in any suitable and desired manner. For example, it may be determined that no error has occurred when the signatures exactly match, and it may be determined that there has been an error when the signatures do not exactly match. Alternatively, it may be determined that no error has occurred when the signatures are sufficiently similar, and it may be determined that there has been an error when the signatures are not sufficiently similar. This later case may, for example, be appropriate in the case of a lossy encoding scheme where signatures are generated from uncompressed/decompressed data values.

Thus, in an embodiment, the codec reads compressed data and metadata (e.g. a signature) associated with the compressed data (that has been generated from associated uncompressed data) from memory, and decompresses the compressed data to produce decompressed data, metadata (e.g. a signature) is then (re-)generated from the decompressed data, and the metadata associated with the compressed data (that was generated from the uncompressed data) and the metadata generated from the decompressed data are compared, and the comparison is used to detect an error.

These embodiments can be achieved in any suitable and desired manner. For example, the processing unit may be configured to generate the metadata (e.g. a signature) (from the uncompressed and/or decompressed data). Additionally or alternatively, the codec may be configured to generate the metadata (e.g. a signature) (from the uncompressed and/or decompressed data).

Thus, in an embodiment, the processing unit comprises a metadata generating circuit, and additionally or alternatively, the codec comprises a metadata generating circuit. The arrangement is in an embodiment such that a metadata generating circuit can generate metadata (e.g. a signature) from (uncompressed) data that the processing unit has generated, and/or from (decompressed) data that the codec has decompressed.

Similarly, the comparison of metadata (e.g. signatures) may be performed by the processing unit, and/or by the codec.

Where metadata (signature) generation and/or comparison is performed by the codec, the codec is in an embodiment triggered to do so by a suitable bus transaction request issued by the processing unit on the communications bus.

Moreover, in the case of the codec generating metadata (e.g. a signature), and/or providing metadata to the processing unit, the metadata may be transported over the communications bus (interconnect) to the processing unit during a bus transaction triggered by the processing unit.

Thus, in an embodiment the processing unit is operable to initiate over the communications bus, a (“codec”) bus transaction that comprises the codec providing metadata (e.g. a signature) (that has been generated by, and/or read from memory by, the codec) to the processing unit via the communications bus, and in an embodiment the processing unit using the provided metadata (signature) to perform a comparison (e.g. for error detection purposes).

Similarly, in the case of the processing unit generating metadata (e.g. a signature), the metadata generated by the processing unit may be transported over the communications bus (interconnect) to the codec during a bus transaction triggered by the processing unit. In this case, the codec may compare the metadata (signature) provided by the processing unit and/or write the metadata (signature) provided by the processing unit to memory.

Thus, in an embodiment the processing unit is operable to initiate over the communications bus, a (“codec”) bus transaction that comprises the processing unit providing metadata (e.g. a signature) that has been generated by the processing unit to the codec via the communications bus, and in an embodiment the codec writing the provided metadata to the memory and/or using the provided metadata to perform a comparison (e.g. for error detection purposes).

In one such embodiment, the metadata (e.g. signatures) is both generated by, and compared by, the codec. This arrangement may allow detection of errors in respect of storage of data in the memory and the compression and decompression process. In an embodiment, however, the metadata (e.g. signatures) is both generated by, and compared by, the processing unit. This arrangement may allow detection of errors in respect of storage of data in the memory and the compression and decompression process, and also in respect of transport of data to and from the processing unit via the communications bus.

Thus, an embodiment of the technology described herein comprises a data processing system comprising:
a processing unit;
a codec; and
a communications bus over which bus transactions to access memory can be performed;
wherein the processing unit is operable to initiate over the communications bus, a bus transaction that comprises the processing unit providing a signature representative of associated compressed data to the codec via the communications bus, and the codec receiving the signature representative of associated compressed data from the processing unit via the communications bus; and
the codec is operable to, in response to the processing unit initiating such a bus transaction over the communications bus, receive a signature representative of associated compressed data from the processing unit via the communications bus.

An embodiment of the technology described herein comprises a method of operating a data processing system that comprises:
a processing unit;
a codec; and
a communications bus over which bus transactions to access memory can be performed;
wherein the processing unit is operable to initiate over the communications bus, a bus transaction that comprises the processing unit providing a signature representative of associated compressed data to the codec via the communications bus, and the codec receiving the signature representative of associated compressed data from the processing unit via the communications bus; and
the codec is operable to, in response to the processing unit initiating such a bus transaction over the communications bus, receive a signature representative of associated compressed data from the processing unit via the communications bus;
the method comprising:
the processing unit initiating over the communications bus, a bus transaction in which the processing unit provides a signature representative of associated compressed data to the codec via the communications bus, and the codec is to receive the signature representative of associated compressed data from the processing unit via the communications bus; and
the codec, in response to the processing unit initiating the bus transaction over the communications bus, receiving the signature representative of associated compressed data from the processing unit via the communications bus.

These embodiments can include, as appropriate, any one or more or all of the optional features described herein. For example, the signature and/or the associated compressed data is in an embodiment written to and/or read from the memory by the codec.

An embodiment of the technology described herein comprises a data processing system comprising:
a processing unit;
a codec; and
a communications bus over which bus transactions to access memory can be performed;
wherein the processing unit is operable to initiate over the communications bus, a bus transaction that comprises the codec providing a signature representative of associated compressed data to the processing unit via the communications bus; and
the codec is operable to, in response to the processing unit initiating such a bus transaction over the communications bus, provide a signature representative of associated compressed data to the processing unit via the communications bus.

An embodiment of the technology described herein comprises a method of operating a data processing system that comprises:
a processing unit;
a codec; and
a communications bus over which bus transactions to access memory can be performed;
wherein the processing unit is operable to initiate over the communications bus, a bus transaction that comprises the codec providing a signature representative of associated compressed data to the processing unit via the communications bus; and
the codec is operable to, in response to the processing unit initiating such a bus transaction over the communications bus, provide a signature representative of associated compressed data to the processing unit via the communications bus;
the method comprising:
the processing unit initiating over the communications bus, a bus transaction in which the codec is to provide a signature representative of associated compressed data to the processing unit via the communications bus; and
the codec, in response to the processing unit initiating the bus transaction over the communications bus, providing the signature representative of associated compressed data to the processing unit via the communications bus.

These embodiments can include, as appropriate, any one or more or all of the optional features described herein. For example, the signature and/or the associated compressed data is in an embodiment written to and/or read from the memory by the codec.

In these embodiments, the same signature (e.g. checksum) generation process may (always) be used, or the signature generation process may be varied. For example, a different seed may be used by different processing units, or whenever writing to a compressed buffer. In one such embodiment, each of plural processing units is associated with a respective unique metadata generation process (e.g. a unique seed). This may allow detection of errors in which data for one processing unit is accidentally overwritten by a different processing unit.

In this case, information indicative of the metadata generation process (e.g. the seed) that was used to generate the metadata may be written to the memory together with the metadata, so that it can be subsequently used when re-generating metadata for comparison purposes.

To facilitate this, the information indicative of a metadata generation process (e.g. seed) may be transported over the communications bus (interconnect) to the codec during a bus transaction triggered by the processing unit.

Thus, in an embodiment the processing unit is operable to initiate over the communications bus, a (“codec”) bus transaction that comprises the processing unit providing information indicative of a metadata generation process to the codec via the communications bus, and in an embodiment the codec writing the information to the memory and/or using the information when generating metadata (e.g. a signature).

In an embodiment the processing unit is operable to initiate over the communications bus, a (“codec”) bus transaction that comprises the codec reading information indicative of a metadata generation process from memory, and providing the information to the processing unit via the communications bus and/or using the information when generating metadata (e.g. a signature).

In an embodiment, the processing unit is operable to initiate over the communications bus, a bus transaction that comprises the codec receiving information indicative of a metadata generation process from, or providing information indicative of a metadata generation process to, the processing unit via the communications bus.

In an embodiment, the data processing system comprises a host processor (and, optionally, a display). In an embodiment, the host processor is operable to execute applications that require data processing by the processing unit, with the processing unit operating in the manner of the technology described herein when required to process data by applications executing on the host processor.

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

A number of embodiments of the technology described herein will now be described.

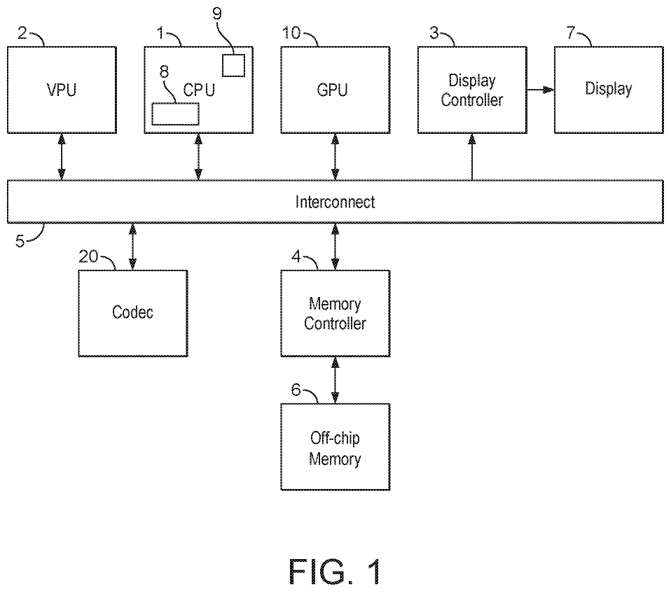

FIG. 1 shows a data processing system in accordance with an embodiment.

The exemplary data processing system shown in FIG. 1 comprises a host processor comprising a central processing unit (CPU) 1, a graphics processor (graphics processing unit (GPU)) 10, a video processing unit (VPU) 2, a display controller 3, and a compression codec 20. As shown in FIG. 1, these processing units can communicate via a bus 5 and have access to an off-chip memory system (memory) 6 via the bus 5 and a memory controller 4. Other processing units may be provided.

In use of this system, the CPU 1, and/or VPU 2 and/or GPU 10 will generate frames (images) to be displayed, and the display controller 3 will provide frames to a display 7 for display. To do this the CPU 1, and/or VPU 2 and/or GPU 10 may read in data from the memory 6 via the interconnect 5, process that data, and return data to the memory 6 via the interconnect 5. The display controller 3 may then read in that data from the memory 6 via the interconnect 5 for display on the display 7.

For example, an application 8, such as a game, executing on the host processor (CPU) 1 may require the display of graphics processing unit rendered frames on the display 7. In this case, the application 8 will send appropriate commands and data to a driver 9 for the graphics processing unit 10 that is executing on the CPU 1. The driver 9 will then generate appropriate commands and data to cause the graphics processing unit 10 to render appropriate frames for display and store those frames in appropriate frame buffers in main memory 6. The display controller 3 will then read those frames into a buffer for the display from where they are then read out and displayed on the display panel of the display 7.

As part of this processing, the graphics processor 10 will read in data, such as textures, geometry to be rendered, etc. from the memory 6, process that data, and then return data to the memory 6 (e.g. in the form of processed textures and/or frames to be displayed), which data will then further, e.g. as discussed above, be read from the memory 6, e.g. by the display controller 3, for display on the display 7.

Thus, there will be a need to transfer data between the memory 6 and processing units (e.g. CPU 1, VPU 2, GPU 10, display controller 3) of the data processing system. In order to facilitate this, and to reduce the amount of data that needs to be transferred to and from memory during processing operations, the data may be stored in a compressed form in the memory 6.

As a processing unit (e.g. CPU 1, VPU 2, GPU 10, display controller 3) will typically need to operate on the data in an uncompressed form, this accordingly means that data that is stored in the memory 6 in compressed form may need to be decompressed before being processed by the processing unit. Correspondingly, data produced by a processing unit (e.g. CPU 1, VPU 2, GPU 10) may need to be compressed before being stored in the memory 6.

To facilitate such compression and decompression of data that passes between the memory 6 and processing units, as shown in FIG. 1, the data processing system includes a compression codec 20 that performs the required compression and decompression operations. In this embodiment, the codec 20 is connected to the bus 5 via a bus interface. In other embodiments, the codec may be integrated in the bus 5.

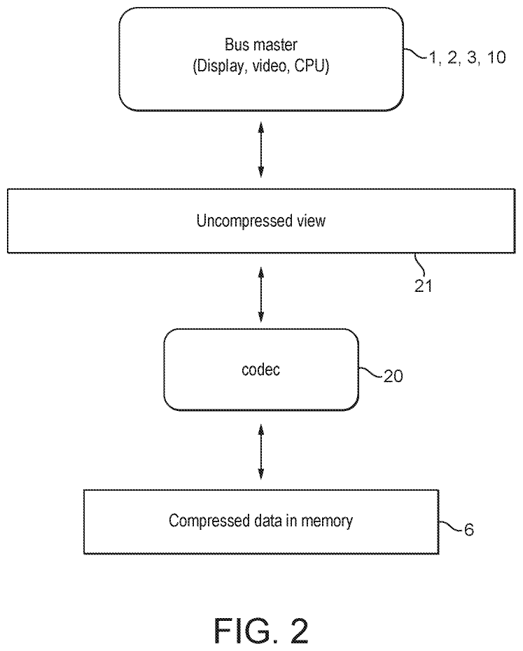

FIG. 2 shows schematically elements of the data processing system that are relevant to the operation of the present embodiments, and in particular to the transferring of data between the memory system 6 and a processing unit in a compressed form. As will be appreciated by those skilled in the art there may be other elements of the system, etc. that are not shown in FIG. 2.

As shown in FIG. 2, the codec 20 is logically between each processing unit (e.g. CPU 1, VPU 2, GPU 10, display controller 3) and the memory 6. The codec 20 is then operable to decompress data received from the memory system 6 before providing that data in an uncompressed form for use by a processing unit, and, conversely, to compress data received from a processing unit 1, 2, 3, 10 that is to be written to the memory system 6 prior to writing that data to the memory 6 in compressed form.

As illustrated in FIG. 2, the codec 20 operates to effectively present an uncompressed view 21 of compressed data in the memory 6 to a processing unit 1, 2, 3, 10 that is acting as bus master, such that the processing unit 1, 2, 3, 10 can access that uncompressed view of the compressed data through bus transactions.

As discussed above, the use of bus transactions to communicate with and control a codec in this manner can provide a particularly flexible arrangement for compression and decompression in a data processing system.

For example, and as illustrated in FIGS. 1 and 2, multiple different processing units 1, 2, 3, 10 can control the same single compression codec 20 using bus transactions, and similarly, a single processing unit can control multiple different codecs using bus transactions. Furthermore, this flexibility can be achieved with relatively small modifications to existing bus protocols, such as AXI. Thus, for example, a processing unit can control a codec using the same bus interface that it uses for other e.g. “direct” bus transactions. Moreover, the compressed data can be accessed in a “random access” manner.

Embodiments of the technology described herein will now be described in the context of compressed image data. However, it will be appreciated that other embodiments relate to other types of compressed data.

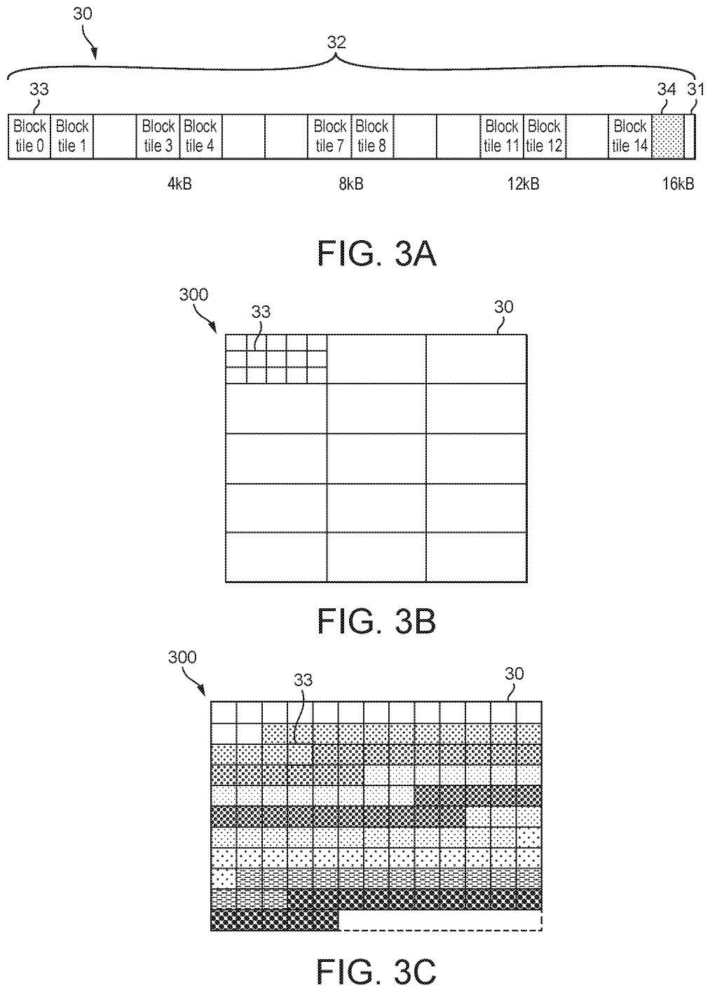

FIG. 3 illustrates the layout of image data stored in memory 6 in compressed form according to embodiments. These embodiments relate to “memory page compression”. It will be appreciated that other memory layouts would be possible.

As shown in FIG. 3, in the present embodiments, compressed image data is stored in one or more compressed frame buffers 300 in memory 6, wherein each compressed frame buffer 300 comprises one or more memory pages 30 of one or more compressed data blocks 33. As shown in FIG. 3B, a compressed frame buffer 300 may include a set of memory pages 30 arranged in scan line order, with compressed data blocks 33 arranged in scan line order within each memory page 30. Alternatively, as shown in FIG. 3C, compressed data blocks 33 may be arranged sequentially in scanline order. Other arrangements would be possible.

As shown in FIG. 3A, in the present embodiments, each memory page 30 is a contiguous set of memory addresses (a “chunk”) that includes a header 31 and body data 32 that includes the compressed data blocks 33. The body data 32 may include an unused, e.g. padding, region 34. As shown in FIG. 3A, each compressed data block 33 in a memory page 30 is associated with a unique index, which runs from 0 to 14 in this example.

Each compressed data block 33 may represent a set of sub-blocks of image data. In the present example, each compressed data block represents 16 sub-blocks of image data, with each sub-block representing 64 bytes of uncompressed image data (e.g. corresponding to the burst size used by the data processing system). Thus each compressed data block 33 represents 1 kB of uncompressed image data. Each memory page accordingly represents 16 kB, as opposed to a typical 4 kB memory page size. Using a larger page size may help to reduce address traffic over the bus. Other arrangements would be possible.

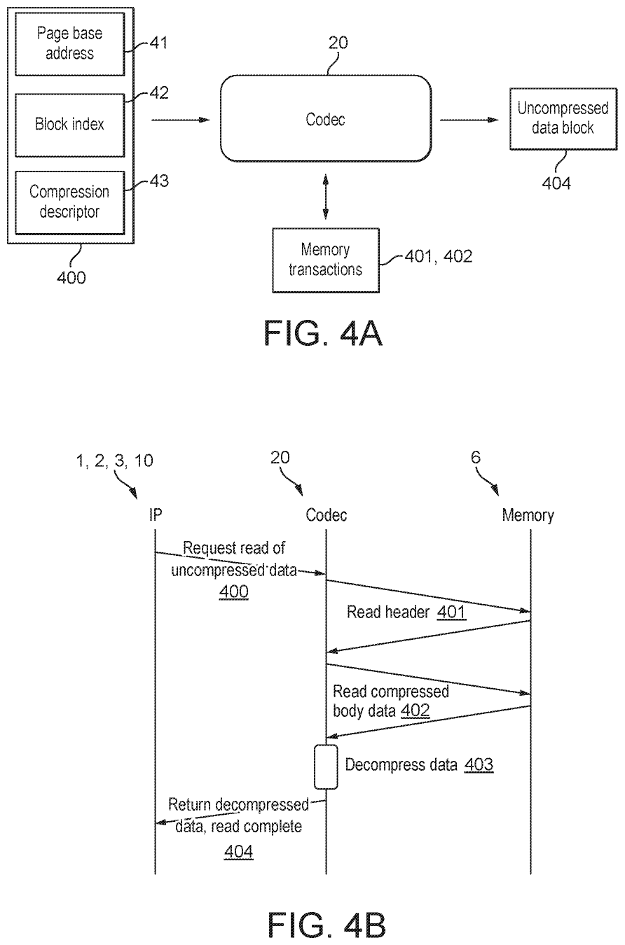

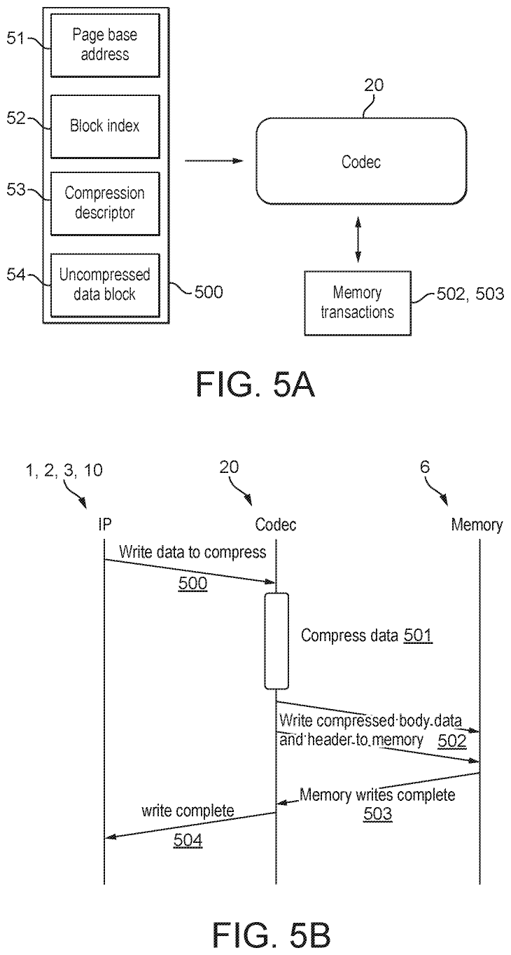

FIGS. 4 and 5 illustrate bus transactions in which a processing unit 1, 2, 3, can access an uncompressed view of compressed image data that is stored in a compressed frame buffer 300 in the memory 6 in accordance with embodiments of the technology described herein.

FIG. 4A schematically illustrates a compressed data read transaction, and FIG. 4B is a corresponding sequence diagram, according to an embodiment.

As illustrated in FIGS. 4A and 4B, when a processing unit 1, 2, 3, 10 requires data that is stored in the memory 6 in a compressed data block 33, the processing unit issues a read transaction request 400 on a read address channel of the bus 5 via its bus interface. This includes the processing unit issuing a “COMPRESSED” signal that indicates that the request relates to compressed data in the memory 6, and should trigger a bus transaction that involves the codec 20.

As shown in FIG. 4A, the read transaction request 400 further includes an indication 41, 42 of the memory address of the required compressed data block, and a compression descriptor 43. The memory address information includes an indication 41 of the location of header data 31 for the compressed data block, and an indication 42 of the location of the block 33 within the body data 32 associated with the header.

The compression descriptor 43 is a signal vector that identifies the compression mechanism (codec) that the required data block is compressed in accordance with, and identifies the data format and data type in which the uncompressed data should be returned to the processing unit (e.g. RGB, RGBA, YUV, number of components, bits per component, whether data values are unsigned/signed integers, floating point numbers, etc.).

As shown in FIG. 4B, the codec 20 recognises and intercepts the request 400, reads 401 header information 31 for the required compressed data block from the memory 6 using the header memory address information 41, and then reads 402 the appropriate compressed data block 33 using the body memory address information 42. The codec then decompresses 403 the read compressed data block in accordance with the compression descriptor information 43, and provides the decompressed data to the processing unit 1, 2, 3, 10 and signals 404 to the processing unit 1, 2, 3, 10 that the read transaction is complete on a read data channel of the bus 5.

FIG. 5A schematically illustrates a compressed data write transaction, and FIG. 5B is a corresponding sequence diagram, according to an embodiment.

As illustrated in FIGS. 5A and 5B, when a processing unit 1, 2, 3, 10 requires (uncompressed) data that is stored in the memory 6 in a compressed data block 33, the processing unit issues a write transaction request 500 on the bus 5 via its bus interface. This includes the processing unit issuing a “COMPRESSED” signal on a write address channel of the bus 5 that indicates that the request relates to compressed data in the memory 6, and should trigger a bus transaction that involves the codec 20.

As shown in FIG. 5A, the write transaction request 500 further includes the (uncompressed) data 54 that the processing unit requires to be stored in compressed form in the memory 6, an indication 51, 52 of the memory address at which the compressed data block should be stored in the memory 6, and a compression descriptor 53. The memory address information includes an indication 51 of the memory location for header data 31 for the compressed data block, and an indication 52 of the memory location for the block 33 within body data 32 associated with the header.

In this case, the compression descriptor 53 is a signal vector that identifies the compression mechanism (codec) that the data should be compressed in accordance with, and identifies the data format and data type in which the uncompressed data is provided (e.g. RGB, RGBA, YUV, number of components, bits per component, and whether data values are unsigned/signed integers, floating point numbers, etc.).

As shown in FIG. 5B, the codec 20 recognises and intercepts the request 500, compresses 501 the uncompressed data 54 in accordance with the compression descriptor information 53, and writes 502 the compressed data block to the memory 6 together with appropriate header information 31 based on the memory address information 51, 52. When the memory write is complete 503, the codec 20 signals 504 to the processing unit 1, 2, 3, 10 that the write transaction is complete on a write response channel of the bus 5.

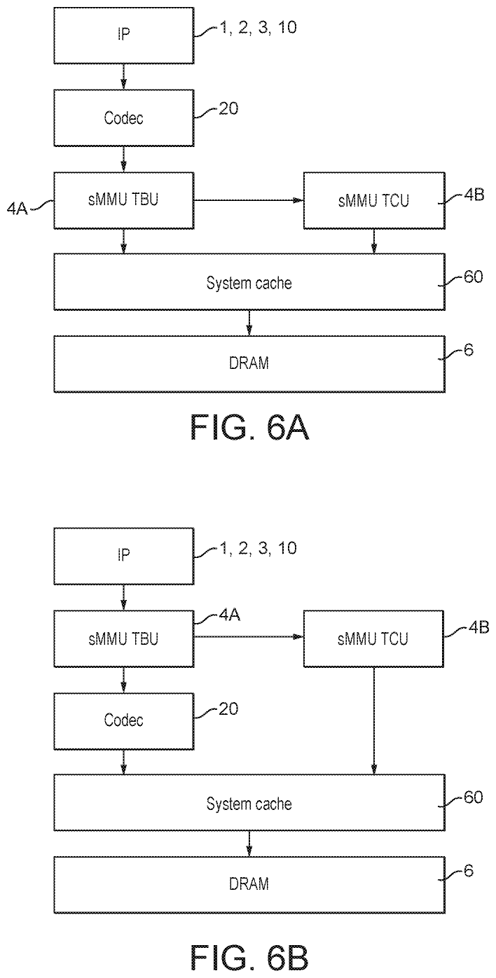

FIGS. 6A and 6B illustrate layouts of data processing systems in accordance with embodiments of the technology described herein. As can be seen in FIGS. 6A and 6B, the memory system may include memory 6 is in the form of dynamic random access memory (DRAM), and an associated cache system 60. The memory controller 4 may comprise a translation buffer unit (TBU) 4A that translates virtual and physical memory addresses, and a translation control unit (TCU) 4B that controls the memory translation operations. Other memory system arrangements would be possible.

The codec 20 is logically between a processing unit 1, 2, 3, 10 and the memory 6, such that the codec 20 can “intercept” bus transaction communications between the processing unit and the memory 6. In the embodiment shown in FIG. 6A, the codec 20 is logically between a processing unit 1, 2, 3, 10 and the memory controller 4A, 4B. In this case, the codec 20 is operable to access the memory 6 via the memory controller 4, and may thus address the memory 6 using virtual memory addresses. In the embodiment shown in FIG. 6B, the codec 20 is logically between the memory controller 4A, 4B and the memory 6. In this case, the codec 20 may address the memory 6 using physical memory addresses.

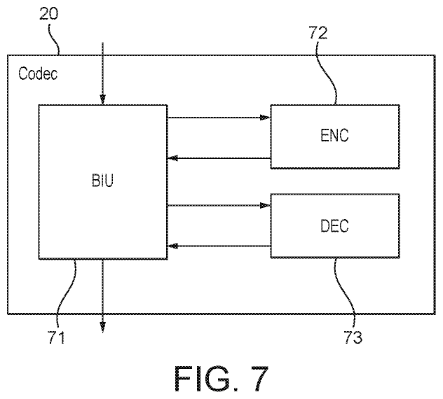

FIG. 7 shows the codec unit 20 in more detail according to an embodiment. As shown in FIG. 7, the codec unit 20 includes a bus interface module (BIU) 71, an encoder module, and a decoder module 73. The bus interface module 71 receives bus transactions via the bus 5 and determines the manner in which the codec 20 should respond to received bus transactions.

In the case of a compressed data read transaction, the bus interface module 71 passes compressed data to be decompressed to the decoder module 73, and the decoder module 73 decompresses the data, and returns decompressed data to the bus interface module 71. The bus interface module 71 then forwards the decompressed data to the processing unit 1, 2, 3, 10. The bus interface module 71 may initiate a bus transaction to read the compressed data to be decompressed from the memory 6.

In the case of a compressed data write transaction, the bus interface module 71 passes data to be compressed to the encoder module 72, and the encoder module 72 compresses the data, and returns compressed data to the bus interface module 71. The bus interface module 71 then forwards the compressed data to the memory 6. The bus interface module 71 may initiate a bus transaction to write the compressed data to the memory 6.

In the case of a bus transaction that is not indicated as being related to compressed data, the bus interface module 71 appropriately forwards the bus transaction without the encoder or decoder modules 72, 73 being activated.

As can be seen in the embodiments shown in FIGS. 4 and 5, the memory address of a compressed memory block is not explicitly indicated, but rather the memory address information is in the form of a memory address of a memory page header 41, 51 and an index 42, 52 of a compressed data block within that memory page. The codec 20 accordingly will determine a memory address of a compressed memory block from the memory page header memory address and block index. In particular, the codec 20 will determine a memory address offset from the block index 42, 52, and apply the determined offset to the memory page header memory address 41, 51 to determine the address of the compressed memory block. As discussed above, this can reduce the amount of information required to indicate a memory address.

In the present embodiments, there is a fixed relationship between block indices and memory address offsets. In particular, as shown in FIG. 3A, in the present embodiment, each memory page 30 has a fixed “chunk” size, and is divided into contiguous memory sub-regions of the same size. A sub-region is reserved for each compressed memory block 33, and for the header data. (In the present embodiment each memory page is 16 kB in size, and each sub-region is 1 kB in size, but other arrangements would be possible.) This means that a memory address offset is “implicit” to each block index, and thus a memory address offset can be determined from an index and the predefined (fixed) relationship between block indices and memory address offsets.

In other embodiments, however, the amount of memory reserved for a compressed data block may vary, e.g. depending on the data, compression scheme, etc. In this case, there may not be a fixed relationship between block indices and memory address offsets. In this case, information indicating the relationship between block indices and memory address offsets may be included in the header 31, in the form of an offset field. In this case, the codec 20 may read offset field information from a header in order to determine the address of a compressed memory block to read. Similarly, the codec 20 may write offset field information to a header when writing a compressed memory block to memory 6. In this case, the offset data in a header may indicate memory address offsets relative to the memory address of the header.

In other embodiments, compressed data may be stored in memory without headers. In this case, a memory address may for example, be directly indicated, or determinable based on a base memory address for a memory page, and an index of a memory sub-region within that page. Other arrangements would be possible.

Although the above generally describes a processing unit triggering a bus transaction in which the codec 20 reads or writes compressed data which is stored as body data associated with a header, in embodiments of the technology described herein, a processing unit can trigger a bus transaction in which the codec reads only header data 31 in the memory 6 without reading the associated body data 32. In particular, a processing unit can issue a request on the bus 5 that triggers the codec 20 to read only header information from the memory 6, and provide the header information to the processing unit via the communications bus 5. Where data is stored without a header, such a header read request may return an indication that no header is present.

In an embodiment, multiple headers may be read in a single transaction, and cached. This can reduce latency in situations where it may be expected to access several neighbouring data blocks in close succession.

Such a header read request may cause the codec 20 to return all of the header data, or only a particular part of the header data. For example, as well as (or instead of) including memory offset information, in embodiments of the technology described herein a header 31 includes metadata that is indicative of one or more properties of the associated body data 32. In this case, a processing unit may issue a READ_META request that will trigger the codec 20 to return only metadata in a header 31 to the processing unit via the communications bus 5 (but not, e.g., any other header data or the associated compressed data). In this case, the bus interface module 71 may initiate a bus transaction to read the metadata from the memory 6.

The metadata may, for example, indicate that the image elements for a compressed data block 33 are all the same colour, and that colour. It may sometimes be the case that a set of image elements are all the same colour in certain types of images, such as a background in a text page or a menu page. In this case, the metadata may be used, e.g. by the display controller 3 when compositing a frame for display on the display 7, to determine a colour to use for a compressed data block without needing to decompress that compressed data block. This can accordingly reduce the processing effort required to decompress image data. Similarly, decompression of a compressed data block may be omitted when metadata indicates that the block relates to fully transparent or fully opaque image data. Moreover, the metadata may provide a direct indication of whether compressed data that the metadata is associated with should be decompressed. For example, the metadata may indicate that all image elements of a set of image elements are not (fully) transparent, not (fully) opaque, and not the same colour.

In embodiments of the technology described herein, a header 31 also (or instead) includes one or more checksums that are used for error detection purposes, e.g. for autonomous vehicle applications. In this case, a checksum may be generated from uncompressed data values, and the uncompressed data values may be compressed by the codec 20 to produce a compressed data block. The checksum may then be stored in a header 31, and the compressed data block stored in the associated body data 32. Then, when the compressed data block is decompressed by the codec 20 to produce decompressed data values, the checksum may be re-generated from the decompressed data values. The checksum generated from the decompressed data values may then be compared with the checksum generated from the uncompressed data values, and the comparison may be used to determine whether an error has occurred.

In one such embodiment, the codec 20 generates, stores and compares the checksums. This may allow detection of errors in respect of storage of data in the memory 6 and the compression and decompression process by the codec 20.

In another such embodiment, however, the checksums are generated and compared by a processing unit. In this case, the checksums may be transported over the bus 5 between the codec 20 and a processing unit during a bus transaction triggered by the processing unit. This may allow detection of errors in respect of storage of data in the memory 6, the compression and decompression process by the codec 20, and also in the transport of data to and from the processing unit via the communications bus 5.

Furthermore, each processing unit 1, 2, 3, 10 may use a unique seed for the checksum generation process. This may allow detection of errors in which data for a processing unit is accidentally overwritten by a different processing unit. In this case, the seed may also be stored in, and read from, a header 31 as appropriate. Moreover, a seed for a processing unit may be transported over the bus 5 between the codec 20 and the processing during a bus transaction triggered by the processing unit.

Although the above describes generating and comparing a checksum, other forms of representative data could be used, such as hash values, etc.

It will be appreciated from the above that the technology described herein, in its embodiments at least, provides improved arrangements for compression and decompression operations in a data processing system. This is achieved, in the embodiments of the technology described herein at least, by a processing unit initiating bus transactions to control a compression codec unit.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A data processing system comprising:
a processing unit;
a codec; and
a communications bus over which bus transactions to access memory can be performed;
wherein the processing unit is operable to initiate over the communications bus, bus transactions that comprise the codec accessing the memory; and
the codec is operable to, in response to the processing unit initiating such a bus transaction over the communications bus, access the memory.

2. The system of claim 1, wherein the processing unit is operable to issue over the communications bus, a signal that indicates that the codec should access the memory, and the codec is operable to access the memory in response to receiving the signal that indicates that the codec should access the memory.

3. The system of claim 1, wherein compressed data is stored in the memory in one or more memory space regions, with each memory space region being divided into one or more memory space sub-regions;
wherein the processing unit is operable to issue over the communications bus, a signal that indicates a memory address for one of the memory space regions and an index indicating one of the memory space sub-regions of that memory space region; and
the codec is operable to, in response to receiving the signal, determine a memory address for the memory space sub-region indicated by the index based on the memory address and index indicated by the signal, and access the determined memory address.

4. The system of claim 1, wherein the processing unit is operable to issue over the communications bus, a signal that indicates a memory address of a header associated with compressed data; and the codec is operable to:
in response to receiving a memory address indicating signal that indicates a memory address of a header associated with compressed data to be read, determine a memory address for the compressed data based on the indicated memory address of the header, and memory address offset information in the header that indicates a memory address offset relative to the memory address of the header for the compressed data; and
in response to receiving a memory address indicating signal that indicates a memory address of a header associated with compressed data to be written, write memory address offset information in the header that indicates a memory address offset relative to the memory address of the header for the compressed data.

5. The system of claim 1, wherein the processing unit is operable to initiate over the communications bus, a bus transaction that comprises the codec compressing data provided by the processing unit to produce compressed data.

6. The system of claim 1, wherein the processing unit is operable to initiate over the communications bus, a bus transaction that comprises the codec decompressing compressed data to produce decompressed data, and providing the decompressed data to the processing unit.

7. The system of claim 1, wherein the processing unit is operable to initiate over the communications bus, a bus transaction that comprises the codec:
receiving, from the processing unit via the communications bus, information indicative of parameters and/or properties to be used when compressing or decompressing data; and
compressing or decompressing data in accordance with the parameters and/or properties indicated by the information.

8. The system of claim 1, wherein the codec comprises an encoder and decoder circuit configured to compress and decompress data, and the processing unit is operable to initiate over the communications bus, a bus transaction that comprises:
the processing unit issuing over the communications bus, a signal that indicates that the codec should access the memory and information indicative of parameters and/or properties to be used when compressing or decompressing data; and
the codec is operable to, in response to receiving the signal over the communications bus, configure the encoder and decoder circuit to compress or decompress data in accordance with the parameters and/or properties indicated by the information.

9. The system of claim 1, wherein the processing unit is operable to initiate over the communications bus, a bus transaction that comprises the codec reading metadata associated with compressed data from the memory without reading the compressed data, and returning the read metadata to the processing unit.

10. The system of claim 1, wherein the processing unit is operable to initiate over the communications bus, a bus transaction that comprises the codec receiving a signature representative of associated compressed data from, or providing a signature representative of associated compressed data to, the processing unit via the communications bus.

11. The system of claim 1, wherein the codec comprises:
a bus transaction initiating circuit configured to initiate over the communications bus, bus transactions to access the memory; and
the codec is operable to access the memory by the bus transaction initiating circuit of the codec initiating over the communications bus, a bus transaction to access the memory.

12. A codec comprising:
a bus transaction initiating circuit configured to initiate over a communications bus, bus transactions to access memory; and
a processing circuit configured to, in response to receiving over the communications bus, a request for the codec to access the memory, cause the bus transaction initiating circuit to initiate over the communications bus, a bus transaction to access the memory.

13. A method of operating a data processing system that comprises:
a processing unit;
a codec; and
a communications bus over which bus transactions to access memory can be performed;
wherein the processing unit is operable to initiate over the communications bus, bus transactions that comprise the codec accessing the memory; and
the codec is operable to, in response to the processing unit initiating such a bus transaction over the communications bus, access the memory;
the method comprising:
the processing unit initiating over the communications bus, a bus transaction in which the codec is to access the memory; and
the codec accessing the memory in response to the processing unit initiating the bus transaction over the communications bus.

14. The method of claim 13, wherein the processing unit initiating the bus transaction comprises the processing unit issuing over the communications bus a signal that indicates that the codec should access the memory, and the codec accessing the memory comprises the codec accessing the memory in response to receiving the signal that indicates that the codec should access the memory.

15-16. (canceled)

17. The method of claim 13, wherein the processing unit initiating the bus transaction comprises the processing unit initiating a bus transaction in which the codec is to compress data provided by the processing unit to produce compressed data; and the method comprises:
the codec, in response to the processing unit initiating the bus transaction:
compressing data provided by the processing unit to produce compressed data.

18. The method of claim 13, wherein the processing unit initiating the bus transaction comprises the processing unit initiating a bus transaction in which the codec is to decompress compressed data to produce decompressed data, and provide the decompressed data to the processing unit; and the method comprises:
the codec, in response to the processing unit initiating the bus transaction:
decompressing compressed data to produce decompressed data; and
providing the decompressed data to the processing unit.

19. (canceled)

20. The method of claim 13, wherein the codec comprises an encoder and decoder circuit configured to compress and decompress data, and the method comprises:
the processing unit issuing over the communications bus, a signal that indicates that the codec should access the memory and information indicative of parameters and/or properties to be used when compressing or decompressing data; and
the codec, in response to receiving the signal over the communications bus, configuring the encoder and decoder circuit to compress or decompress data in accordance with the parameters and/or properties indicated by the information.

21. The method of claim 13, wherein the processing unit initiating the bus transaction comprises the processing unit initiating a bus transaction in which the codec is to read metadata associated with compressed data from the memory without reading the compressed data, and return the read metadata to the processing unit; and the method comprises:
the codec, in response to the processing unit initiating the bus transaction:
reading metadata associated with compressed data from the memory without reading the compressed data; and
returning the read metadata to the processing unit.

22. The method of claim 13, wherein the processing unit initiating the bus transaction comprises the processing unit initiating a bus transaction in which the codec is to receive a signature representative of associated compressed data from, or provide a signature representative of associated compressed data to, the processing unit via the communications bus; and the method comprises:
the codec, in response to the processing unit initiating the bus transaction:
receiving a signature representative of associated compressed data from, or providing a signature representative of associated compressed data to, the processing unit via the communications bus.

23. The method of claim 13, wherein the codec comprises a bus transaction initiating circuit configured to initiate over the communications bus, bus transactions to access the memory; and
the codec accessing the memory comprises the bus transaction initiating circuit of the codec initiating over the communications bus, a bus transaction to access the memory.

24-25. (canceled)
